(19) United States
(12) Patent Application Publication
(10) Pub. No.: US 2026/0001253 A1
(43) Pub. Date: Jan. 1, 2026

(54) SYSTEMS AND METHODS FOR PRODUCTION OF READILY COMPRESSIBLE DIES FOR ENHANCED SINTERING OF SOLIDS

(71) Applicant: Lawrence Livermore National Security, LLC, Livermore, CA (US)

(72) Inventor: Harry CHARALAMBOUS, Livermore, CA (US)

(21) Appl. No.: 18/758,613

(22) Filed: Jun. 28, 2024

(51) Int. Cl. B28B 3/02; B22F 3/03; B30B 11/02; B30B 15/02

(52) U.S. Cl. CPC B28B 3/024; B22F 3/03; B30B 11/027; B30B 15/022

(57) ABSTRACT

The present disclosure relates to a method for molding a part with a selected compaction. The method may involve providing a die having a main body portion and a movable punch movable along a uniaxial axis of movement. An interior area of the main body portion of the die is at least partially filled with a compressible intermediary material, wherein the compressible intermediary material forms a powder. A part is placed in the main body portion of the die such that the part is at least partially encapsulated within the compressible intermediary material. The movable punch is then used to apply a uniaxial force to the part and the compressible intermediary material, wherein the intermediary material assists in providing a desired degree of compaction to the part.

### FEDERALLY SPONSORED RESEARCH OR DEVELOPMENT

This invention was made with Government support under Contract No. DE-AC52-07NA27344 awarded by the United States Department of Energy. The Government has certain rights in the invention.

### FIELD

The present disclosure relates to systems and methods for manufacturing complex-shaped, high-density parts, and particularly to systems and methods which create and employ a compressible mold or die which enables translation of uniaxial pressure to consolidation of variable thickness parts which have an engineered density throughout, and which can be finally processed to a near-net-shape final part.

### BACKGROUND

The statements in this section merely provide background information related to the present disclosure and may not constitute prior art.

With presently available manufacturing technologies, ceramics need to be sintered at high temperatures and pressures to achieve sufficiently high density and desired performance for parts being used in a wide variety of applications. However, fabricating high-density, complex-shaped ceramics is either prohibitively expensive using current methods or requires costly post-machining.

Generally speaking, to further help understand this challenge, FIG. 1a-1c illustrate how a flat geometry part would have a uniform (i.e., non-variable) density throughout the full volume of the part (FIG. 1a), while FIG. 1b shows how a rigid, non-flat punch results in a thicker region of a non-flat geometry part being less dense (i.e., <100%) than the remainder of the part. FIG. 2 illustrates how the compaction created within different regions of a non-flat geometry part differs when a rigid flat punch is used versus when a rigid inverse cone punch is used in a pressing operation, and how this compaction difference varies depending on a distance from the radial center of the part.

One particular present day method for fabricating high-density, complex-shaped ceramics is Pressureless sintering (“PS”). Pressureless sintering requires high processing temperatures, and often requires sintering aids (contaminants), and may also result in unacceptable warpage. Other present-day techniques for fabricating high-density complex-shaped ceramics are Uniaxial hot pressing (“HP”) or spark plasma sintering (“SPS”). However, these approaches are limited in part by complexity, and more particularly due to fixed travel distances of the rigid punches being used. Also, near-net-shaping is currently unfeasible using traditional hot pressing as rigid molds suffer from the travel distance problem, i.e., thicker sections of the part must shrink more in absolute distances and this cannot be accommodated by rigid punches. As a result, these approaches often produce unacceptable density gradients in the finished parts.

Still another approach for fabricating high-density, complex-shaped ceramic parts is Hot isostatic pressing (“HIP”). However, a significant drawback with HIP is that it is slow and exceedingly expensive, requiring initial pre-sintering steps to achieve closed porosity and high-cost, large facilities to implement.

Accordingly, a strong need remains for a system and method that makes use of molds which enable uniform, uniaxial pressure to be applied to a variable thickness part during a sintering process, to overcome the above-described limitations in manufacturing high-density, complex-shaped ceramic parts.

### SUMMARY

This section provides a general summary of the disclosure, and is not a comprehensive disclosure of its full scope or all of its features.

In one aspect the present disclosure relates to a method for molding a part with a selected compaction. The method may comprise initially providing a die having a main body portion and a movable punch movable along a uniaxial axis of movement. The method may further include at least partially filling an interior area of the main body portion of the die with a compressible intermediary material, the compressible intermediary material forming a powder. The method may further include placing a part in the main body portion of the die such that the part is at least partially encapsulated within the compressible intermediary material. The method may further include using the movable punch to apply a uniaxial force to the part and the compressible intermediary material, wherein the compressible intermediary material assists in providing a desired degree of compaction to the part.

In another aspect the present disclosure relates to a method for molding a part with a selected compaction. The method may comprise providing a die having a main body portion and a movable punch movable along a uniaxial axis of movement. The method may also comprise at least partially filling an interior area of the main body portion of the die with a compressible intermediary material, the compressible intermediary material forming a powder, and then placing a part in the main body portion of the die such that the part is at least partially encapsulated within the compressible intermediary material. The method may further include using the movable punch to apply a uniaxial force to the part and the compressible intermediary material, wherein the compressible intermediary material assists in providing a desired degree of compaction to the part. The method may also include sintering the part while the part remains in the die by heating the die for a predetermined time period and at a predetermined temperature.

In still another aspect the present disclosure relates to a system for molding a part with a selected compaction. The system may comprise a die having a main body portion and a movable punch movable along a uniaxial axis of movement. A compressible intermediary material forming a powder may be included. The powder fills an interior area of the main body portion of the die and at least partially encapsulates a part within the powder. The system may also include a controller configured to control the movable punch to cause the movable punch to apply a uniaxial force to the part and the compressible intermediary material, wherein the compressible intermediary material assists in providing a desired degree of compaction to the part in response to the uniaxial force.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

Corresponding reference numerals indicate corresponding parts throughout the several views of the drawings.

FIG. 1a is a simplified side view of a prior art die with a flat punch, and starting with a material to be compacted in a state of 50% compaction within the die, and then showing the material compacted uniformly to 100% using the flat punch;

FIG. 1b simplified side view of a prior art die showing a quantity of material within the die starting at 50% compacting, and then using a non-flat punch to compact the material, and where the compacted material has a non-uniform compaction with the lower area of the die being compacted to less than 100%, while the material in the upper area of the die is compacted to a greater degree than the material in the lower area of the die;

FIG. 2 is a graph illustrating how the compaction of a material with a rigid flat punch is uniform across a radial dimension of the part material being compacted, while the compaction of the material is reduced in a dimension moving radially away from a radial center of the material;

FIG. 3 is a high level illustration of one embodiment of a system in accordance with the present disclosure showing a cone part being compressed and achieving 100% density using a compressible intermediary material;

FIG. 4 shows the cone part compressed with a 100% density due to the presence of the compressible intermediary material;

FIG. 5 illustrates a simplified side view of a die with a flat punch, where the die is filled with a compressible intermediary material comprised of two distinctly different material types to provide an engineered morphology to the compressible intermediary material, and further showing a cone part placed within the intermediary material inside the die about to be compacted;

FIG. 6 shows the cone part of FIG. 5 having been compressed, and illustrating how the compressible intermediary has been compacted during the operation;

FIG. 7 is a graph showing how the compaction (i.e., compressibility) of individual constituents (intermediary or cone) varies as one moves away from a radial center of the material;

FIG. 8 is a graph showing how the compressibility of a system (intermediary material+cone) varies from a radial center of the cone, along with an ideal condition where compressibility is uniform along a radial dimension of the cone;

FIGS. 9-12 show a sequence of compressing a gel-cast ceramic part 304 in the die 12 along with a plastic cone to pre-compact an intermediary compressible material and provide a region within the die for receiving the gel-cast part, and where FIGS. 10a and 11a are views of the die corresponding to FIGS. 10 and 11, but looking down into the die;

FIGS. 13-16 are elevation views of a green part cone, a compacted graphite mold part, a compacted carbon mold part and a compacted hBN mold part;

FIG. 17 is a chart explaining the porosity (“p”) along with a radial-to-height shrinkage percentage for each of the cones shown in FIGS. 13-16; and

FIG. 18 is a high-level flowchart illustrating one example of various operations that may be carried out in creating in a compacted part using the system of FIG. 3.

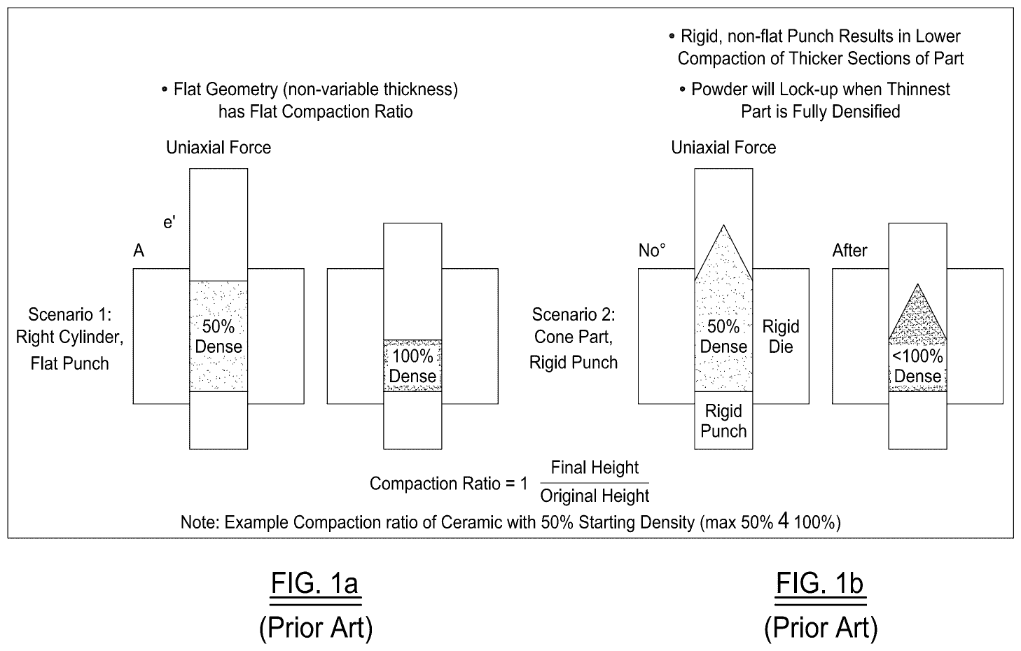

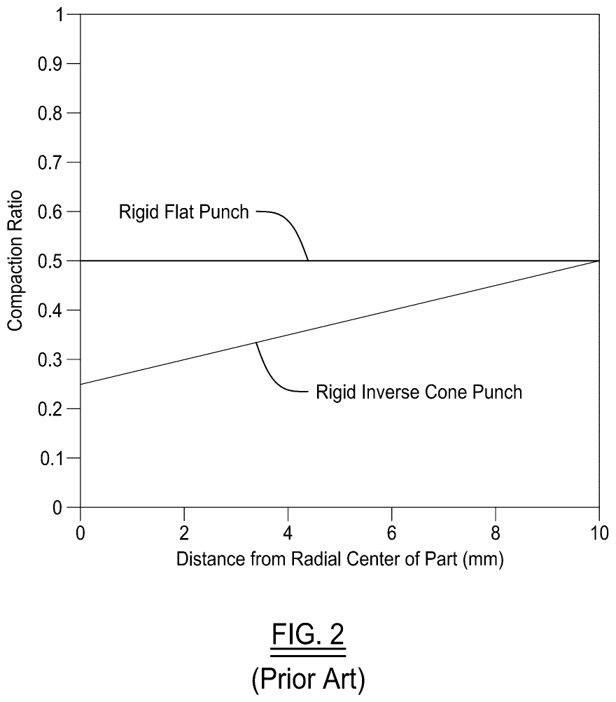

### DETAILED DESCRIPTION

Example embodiments will now be described more fully with reference to the accompanying drawings.

The present disclosure relates to systems and methods PRESS that make use of compressible, non-sintering carbon powder materials which are used as a mold, and which can match the compaction of ceramics during pressure-assisted sintering. The systems and methods of the present disclosure enable an engineered deformation, or a uniform deformation, of the part under a constant linear travel of a punch system being used to compress the material which is being used to form a part during a compaction operation. The present system and method involves considering several important factors for this purpose:

the compressibility of virgin powder materials (e.g., carbon) of varying particle sizes and morphologies as a function of temperature and pressure via Spark Plasma Sintering (SPS);

combining two or more powder materials of different particle sizes at various ratios to create an engineered, variable compaction of a part, or to create different degrees of compaction for different regions of a single part; and

determining the processing conditions of the part material (e.g., ZrB2/SiC composite) in simple geometry.

Referring to FIG. 3, a high-level block diagram of a system 10 is shown for compacting a part. In this example the system 10 may make use of a die 12 having a movable punch 12a, and a rigid punch 12b and a rigid main body portion 12c. In this example the rigid die 12 does not form part of the overall system 10, but in some implementations it may be tailored or customized in a manner such that it may be considered part of the system 10.

The system 10 further may include a press system 14 for applying a uniaxial force to the movable punch 12a. The press system 14 may be controlled using signals from an electronic controller or computer 16 (hereinafter simply “controller 16”). The controller 16 may include a memory 18 including one or more different types of memory (e.g., RAM/ROM/DRAM, etc.) for storing information 20 pertaining to one or more data tables, look-up tables performance curves, temperatures, etc. for specific types/shapes of parts and/or specific materials being used to make parts.

FIG. 3 shows the die 12 with a cone shaped part 22 placed within

the die, and with an intermediary compressible material 24 filling a remainder of a mold cavity 12d of the die 12. In this example the cone shaped part 22 has a density of 50% before the compaction operation is performed.

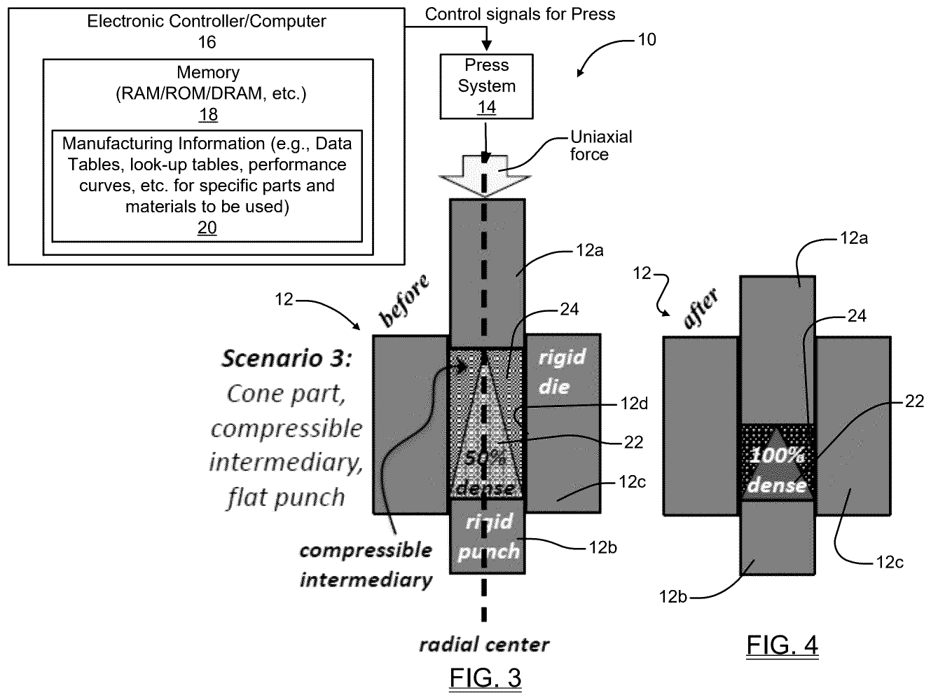

FIG. 4 shows the cone shaped part 22 after the compaction operation has been performed using the die 12 and the system 10 in FIG. 3. The cone shaped part 22 has been compressed and reduced significantly in height, but importantly it now has a density of 100%. In other words, the density of the part is uniform throughout. The intermediary compressible material 24 can also be seen to have been compressed during the compaction operation.

In FIG. 3 the rigid punch 12c remains stationary during the compaction process. However, it will be appreciated that in some dies this component could move uniaxially as well during the compaction process. Therefore, the present disclosure is therefore not limited to using only a single uniaxially moving punch element.

The material used for the intermediary compressible material 24 may vary depending on the desired compaction/density to be achieved in the final part being produced. However, it is expected that a wide variety of powders may be utilized as the compressible intermediary material, such as, without limitation, powders comprising one or more of graphite, carbon, hexagonal boron nitride, and any other oxides, borides, nitrides, carbides, or salts that are non-sintering in the relevant temperature range.

FIGS. 5 and 6 illustrate two different compressible intermediary powders 30 and 32 being used within the mold 12 to help compact a cone shaped part 34. In this example powder 30 represents different morphologies to control the compact behavior. For powder 32, different sized grains are being mixed to control the compaction behavior. FIG. 6 shows how the two different compressible intermediary powders have been compacted, as well the part 34. In some implementations two or more distinctly different compressible intermediary materials may be homogenously mixed together to form one composite compressible intermediary material. By mixing two or more different types of being used, the intermediary compressible material can be customized to provide a highly selective, engineered compaction to the final part being manufactured. Potentially, different regions of the mold cavity 12d could be filled with distinctly different compressible intermediary material powders. For example, a bottom ⅓ of the mold cavity 12d could be filled with a first compressible intermediary powder, then the middle ⅓ filled with a second, different compressible intermediary powder, and the upper ⅓ of the mold cavity 12d filled with a third, different compressible intermediary powder. Those skilled in the art will appreciate this is but one example, and the ability to mix different types of compressible intermediary materials, as well as to fill different distinct regions of the mold cavity 12d with different compressible intermediary materials or formulations of different compressible intermediary materials, provides a wide degree of latitude in producing a highly selective, engineered compaction to the final part being formed in the die 12d. The engineered compaction may produce a uniform compaction throughout the entire volume of the part, or it may produce two or more varying degrees of compaction throughout the part, or two or more different layers of compaction within the volume of the part.

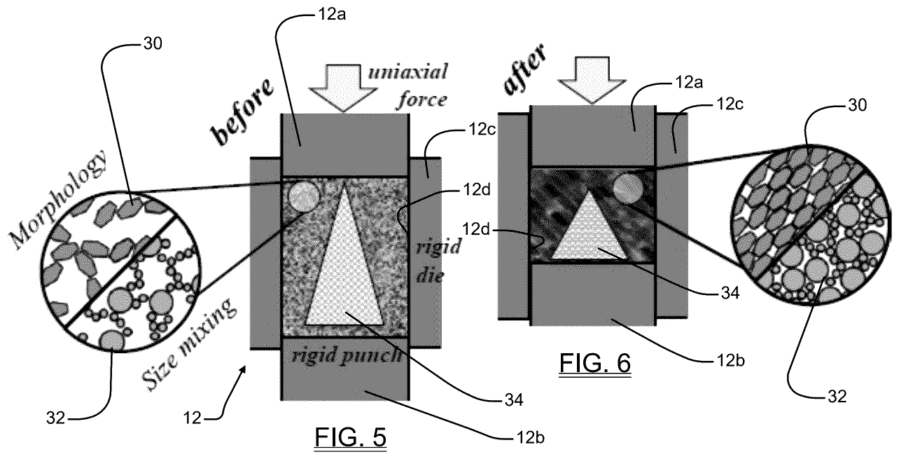

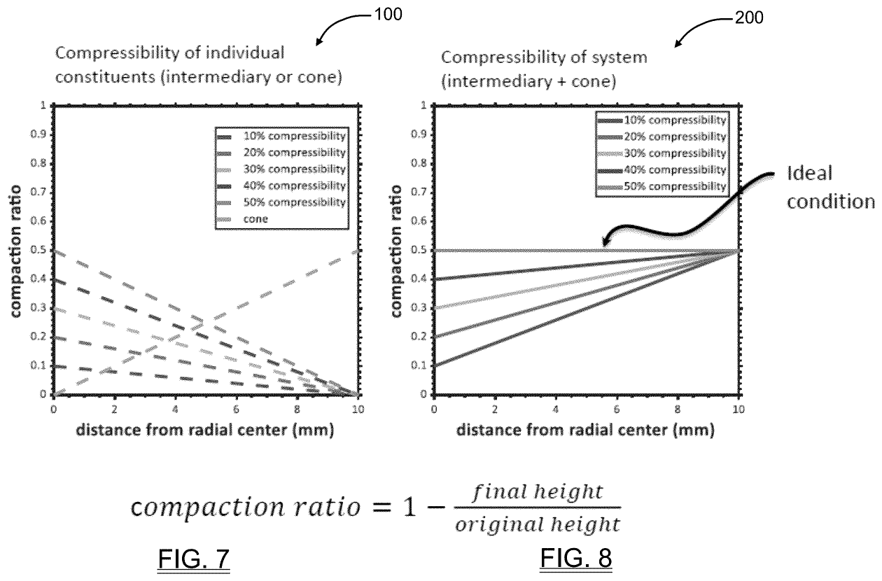

Referring briefly to FIG. 7, a graph 100 shows a plurality of compaction ratio curves showing how, for different percentages of compaction of a given compressible intermediary material or a cone shaped part, the compaction ratio decreases as one moves from a radial center of the mold cavity 12d (i.e., at “0”) to an inner wall of the mold cavity (i.e., at “10”), as well as how the compaction ratio experienced by a cone shaped part changes from a radial center of the part to an outer edge of the part.

Referring briefly to FIG. 8, a graph 200 shows curves illustrating how the overall compaction ratio changes for the compressible intermediary material plus the cone shaped part in combination, according to a distance from a radial center of the part to an outer edge of the part. In this example the 50% curve illustrates what would be considered an “ideal condition” wherein compaction of the mold matches compaction of the part.

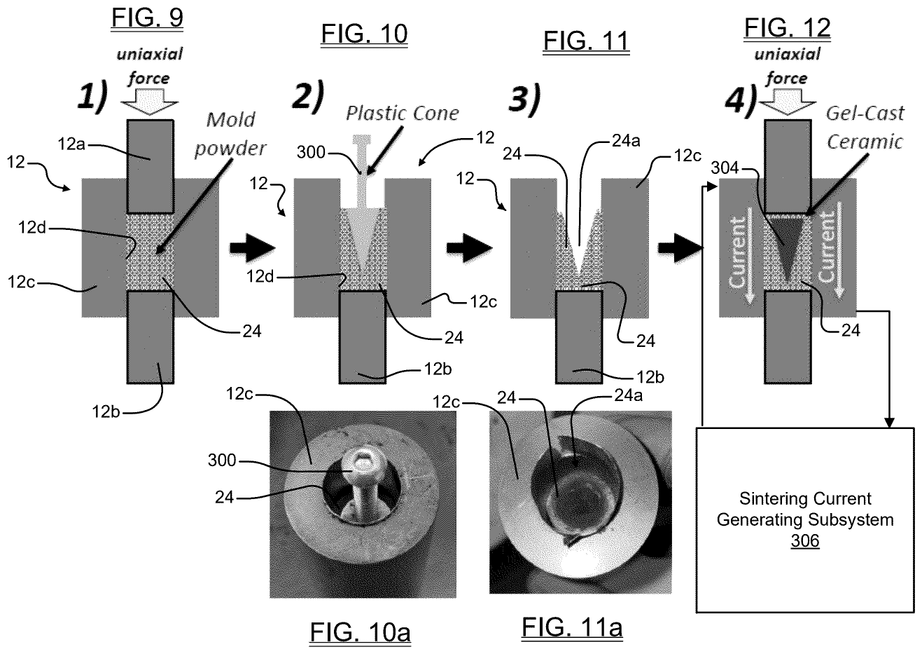

FIGS. 9-12 show how the compressible intermediary material 24 may be “pre-compacted” within the mold cavity 12d of the die 12 using an additional implement 300, prior to performing a main compaction operation with the die 12. In this example the additional implement 300 forms a cone similar or identical in shape and dimension to a part 304 that is being pressure sintered. FIG. 10a shows a top perspective view of the additional implement 300 residing within the compressible intermediary material 24 (corresponding to FIG. 10). FIG. 11a shows how the additional implement 300 has been pressed into the compressible intermediary material 24 to pre-compact the material and create a void 24a therewithin the shape of the additional implement 300. FIG. 11a shows a top view of the void 24a.

In FIG. 12 the part 304 is then inserted into the void 24a and a small quantity of additional compressible intermediary material 24 may be placed on top of the part to create a relative flat surface. The movable rigid flat punch 12a is then controlled by the press system 14 (shown in FIG. 3) to apply a uniaxial force to compact the part 304 while a current generating subsystem 306 applies a current to the die 12 to sinter the part 304. In this example the part 304 is a gel-cast ceramic cone shaped part, although this is but one example and the part may have other shapes and be formed from other materials. The creation of a part negative comprised of the compressible intermediary material shown in 24 is one way with alternatives including casting or printing methods to create the geometry.

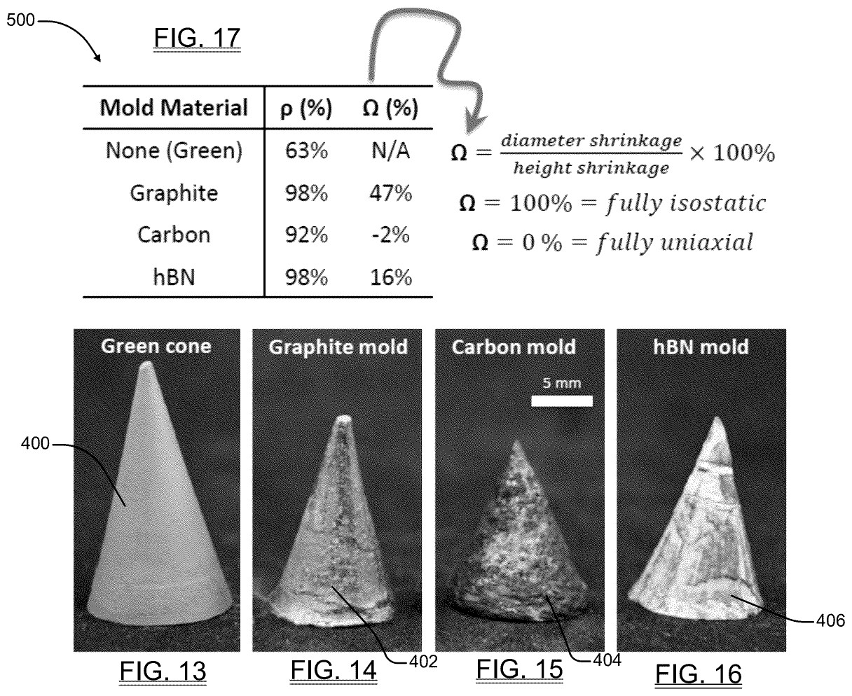

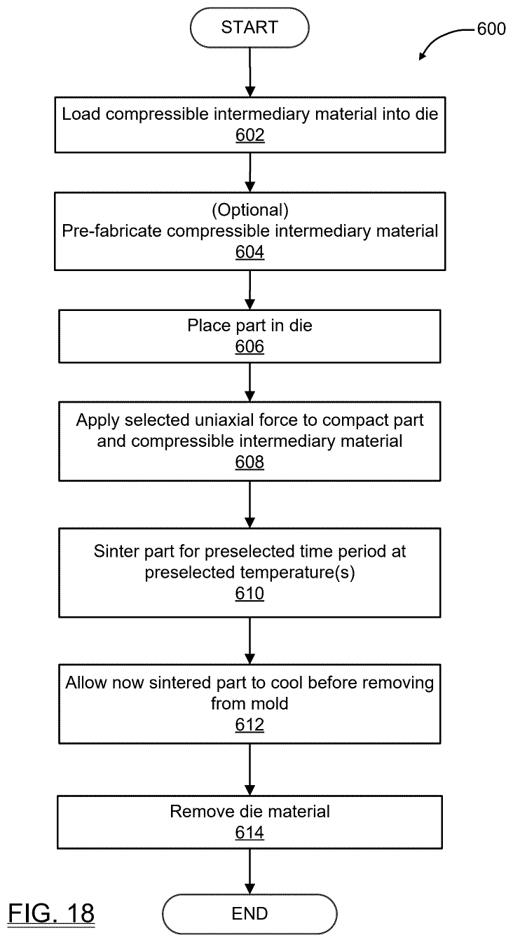

FIGS. 13-16 show a green cone 400, a graphite molded cone 402, a carbon molded cone 404 and a hBN (hexagonal Boron-Nitride) cone 406 after being compacted using the system 10. FIG. 17 shows the density (ρ) as a percentage value that was achieved for the parts 400-406 after compaction, as well as a compaction ratio (Ω) of diameter shrinkage-to-height shrinkage that was achieved for each of the parts 400-406. A compaction ratio (Ω) of 100% means that all of the shrinkage took place uniformly in all directions, whereas a compaction ratio of 0% means the part was compacted entirely along the axis of movement of the movable rigid punch 12a. It is expected that a wide range of other materials may be of interest for use with the system 10 in forming sintered part, and such materials may include, without limitation, ZrB2/SiC composite, B4C, SiC, Si3N4, as well as other ceramics and composites including carbides, borides, nitrides, oxides and composites therein.

It will also be appreciated that the densification achieved for a given part will in most instances vary depending on the material being used to construct it, all other factors being equal. Densification will also vary based on the temperature and/or time during which the part is sintered in the die 12, and/or if the compressible intermediary material 24 has been pre-compacted before the sintering compaction/sintering is performed.

Referring to FIG. 18, a high level flowchart 600 is shown illustrating one example of various operations that may be carried out in compacting/sintering a part to create a part having a near-net final shape. At operation 602 a compressible intermediary material (e.g., material 24), which may be in powdered form, may be loaded into a main body portion of the die. Optionally, the compressible intermediary material may be pre-compacted using a suitable element (e.g., cone 300), as indicated at operation 604 or fabricated into the negative geometry of the part for combined assembly into the die. At operation 606 the part to be compacted/densified may be placed in the interior area of the main body part of the die. At operation 608 a selected uniaxial force may then be applied to compact the part along with the compressible intermediary material. At operation 610 the now compacted part may be sintered for a preselected time period at one or more preselected temperatures (e.g., either a constant sintering temperature or a temperature in accordance with a ramped temperature profile). The temperature or temperatures selected may vary widely depending on the material of the part being sintered and/or the compressible intermediary material being used, but typical sintering temperatures are 500-2500 degrees C. Likewise, the time period for sintering will vary but in many instances will typically between 0.5 hours-50 hours. At operation 612 the now sintered part may be allowed to cool for a preselected time before removing the sintered and compacted/densified part from the main body portion of the die. At operation 614 the die material may then be removed.

The present disclosure thus provides a near-net-shaping production capability for producing complex-shaped without the need for custom tooling, and thus supports a variety of manufacturing needs involving high-density, complex-shaped parts. The systems and methods disclosed herein bridge the gap between traditional sintering and innovations in state-of-the-art advanced manufacturing. The applications presented herein can be further expanded to highly complex geometries including, but not limited to gears, turbines, and spatially selective mixing of powder for finely controlled compaction and selectively engineering pressure gradients, supporting a wide range of part fabrication needs including scale-up and fabrication of more complex parts.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items. As used herein, the term “about”, when used immediately previous to a specific recited value, denotes the specific recited value as well as all values, inclusive, from +/−10% of the specific recited value.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A method for molding a part with a selected compaction, the method comprising:
providing a die having a main body portion and a movable punch movable along a uniaxial axis of movement;
at least partially filling an interior area of the main body portion of the die with a compressible intermediary material, the compressible intermediary material forming a powder;
placing a part in the main body portion of the die such that the part is at least partially encapsulated within the compressible intermediary material; and
using the movable punch to apply a uniaxial force to the part and the compressible intermediary material, wherein the compressible intermediary material assists in providing a desired degree of compaction to the part.

2. The method of claim 1, wherein the part is fully encapsulated in the compressible intermediary material.

3. The method of claim 1, wherein the compressible intermediary material comprises at least one of:
graphite;
carbon;
hBN;
an oxide;
a boride;
a carbide;
a nitride.

4. The method of claim 3, wherein the compressible intermediary material comprises at least two of:
graphite;
carbon;
hBN; or
an oxide;
a boride;
a carbide;
a nitride.

5. The method of claim 1, wherein the part is sintered after being compacted in the die.

6. The method of claim 5, wherein the sintering temperature ranges from 500 degree C. to 2500 degrees C.

7. The method of claim 5, wherein the sintering is carried out for a time period of between 0.5 hours to 50 hours.

8. The method of claim 1, wherein the part is comprised of at least one of:
a ceramic;
a metal;
graphite or carbon.

9. The method of claim 1, further comprising using a controller and a press system to control the movable punch in applying the uniaxial force.

10. The method of claim 1, further comprising using an additional element to pre-compact the compressible intermediary material and create a void within the compressible intermediary material, and then placing the part in the void.

11. The method of claim 1, wherein the additional element creates the void with a three dimensional shape similar to the part.

12. A method for molding a part with a selected compaction, the method comprising:
providing a die having a main body portion and a movable punch movable along a uniaxial axis of movement;
at least partially filling an interior area of the main body portion of the die with a compressible intermediary material, the compressible intermediary material forming a powder;
placing a part in the main body portion of the die such that the part is at least partially encapsulated within the compressible intermediary material;
using the movable punch to apply a uniaxial force to the part and the compressible intermediary material, wherein the compressible intermediary material assists in providing a desired degree of compaction to the part; and
sintering the part while the part remains in the die by heating the die for a predetermined time period and at a predetermined temperature.

13. The method of claim 12, wherein the predetermined temperature ranges from 500 degrees C. to 2500 degrees C.

14. The method of claim 12, wherein the predetermined time period ranges from 0.5 hours to 50 hours.

15. The method of claim 12, wherein the compressible intermediary material comprises at least one of:
graphite;
carbon
hBN; or
an oxide;
a boride;
a carbide;
a nitride.

16. The method of claim 12, wherein two dissimilar materials are used to form the compressible intermediary material.

17. The method of claim 16, wherein the at least dissimilar materials are uniformly intermixed within the die to form the compressible intermediary material.

18. The method of claim 16, wherein the at least two dissimilar materials are arranged in distinct layers within the die.

19. A system for molding a part with a selected compaction, the system comprising:
a die having a main body portion and a movable punch movable along a uniaxial axis of movement;
a compressible intermediary material forming a powder, the powder filling an interior area of the main body portion of the die and at least partially encapsulating a part within the powder; and
a controller configured to control the movable punch to cause the movable punch to apply a uniaxial force to the part and the compressible intermediary material, wherein the compressible intermediary material assists in providing a desired degree of compaction to the part in response to the uniaxial force.

20. The system of claim 19, further comprising a subsystem in communication with the die to heat the die to sinter the part after the part has been compacted within the die.
